(19) United States
(12) Patent Application Publication
(10) Pub. No.: US 2020/0380441 A1
(43) Pub. Date: Dec. 3, 2020

(54) Cloud-Based Workflow for ISP Services Management

(71) Applicant: Girish Altekar, Austin, TX (US)

(72) Inventor: Girish Altekar, Austin, TX (US)

(21) Appl. No.: 16/423,982

(22) Filed: May 28, 2019

(51) Int. Cl. G06Q 10/06; G06F 16/80; G06Q 20/06; H04L 12/24

(52) U.S. Cl. CPC G06Q 10/06315; G06Q 10/063114; H04L 41/5064; G06Q 20/06; G06F 16/80

(57) ABSTRACT

A business process and supporting system that incorporates the resulting cloud-based workflow to procure and manage broadband and related services. The business process is divided into its component steps. All communication is abstracted into structured data allowing for a systematic and error free process. Tools are built into the system to enhance ease of use, and eliminating time wasting effort. An algorithmic approach to matching Customer needs to ISP offerings provides a very efficient and cost-effective way to manage a very real need for multi-location businesses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### 1. Field of the Invention

This invention relates to optimizing the procurement of Internet broadband and related services. More particularly, by creating a web-based workflow that optimally connects Customers with systems and people in Internet Service Provider organizations (ISPs), significant reductions in costs and service losses and improvements in service identification, evaluation, selection and delivery is achieved.

### 2. Description of Related Art Including Information Disclosed Under 37 CFR 1.97 and 1.98

The number of Internet based services is expanding exponentially. Most services are purchased by Customers today over the internet or telephone. Successful commerce for these services requires that Customers research, price, procure these services easily and securely over and manage the use of the service over its lifetime. This need is applicable for both business and Residential Customers.

The present invention targets procurement of Internet Access services from Internet Service Providers (ISPs). Such procurements offer specific challenges to Business Customers (Customers) not just in procurement, but ongoing management of the services procured and deployed. While the current invention primarily addresses the needs of business customers, one with a little familiarity of the domain will discern that the solutions apply to residential customers also.

Current state of the art dictates that Customers use ad hoc, unstructured methods with service provider representatives for communication, procurement and management of these services. Unstructured communication in our problem domain poses many problems for customers and ISPs.
a. Duplication of Effort: To research services available for a location, Customers must contact multiple potential vendors, providing the same information multiple times.
b. Unstandardized Responses—ISPs responses to requests are in non-standard formats that vary from company to company and from ISP Representative (Rep) to Rep. Customers must manually evaluate, normalize and correlate the provider responses to make them susceptible to a valid, apples to apples comparison.
c. Process Complexity—Upon selecting a service provider, Customers begin a detailed dialog with the service provider's representatives to confirm the suitability and completeness of the service for their specific requirements. For example, is the service available at the required location? Is construction required, what is the conceivable schedule. A contract for delivering the service and its prerequisites needs to be created and ratified. Included in the process are a series of complex activities requiring facilitation and coordination of surveys, construction, delivery, installation, configuration and validation of procured services.
d. Poor Records Management—In the post-installation phase, problems often arise and are exacerbated by poor record keeping on the Customers' side. Customer personnel involved with the services installation process are often unavailable later which leads to a loss of critical account and service information—a shortfall that becomes noticeable at service interruptions.
e. Geographic Variations—Contract terms and conditions often vary based on geographical region and the governing entities. These problems are compounded if, as is often the case, SPs maintain multiple geographic service provider locations or different organizations for different services causing communications to be rerouted multiple times before they reach appropriate personnel.
f. Multiple Simultaneous Procurement—Problems are further compounded if the Customers also has, many locations in simultaneous but different stages of activation, usage or termination.
   During the entire lifecycle there are issues related to dropped communication, misplaced records, and personnel changes contributing to these problems that collectively cause significant distress and economic loss resulting from missed deadlines, systems being down and repair actions delayed.

The present invention alleviates communication problems and data loss described above by orchestrating and directing a formal workflow based on structured data and stored information. This workflow dramatically minimizes the time a Customer spends in procurement activities. It reduces the time an ISP sales representative spends in the process, enabling them to service more Customers. It prevents loss of information throughout the procurement processes and increases efficiency by eliminating the need to retype or cut and paste the data multiple times, reducing the manual work and tremendously increasing the accuracy of the data throughout the life cycle of the service instance.

### BRIEF SUMMARY OF THE INVENTION

The present invention defines an automated, rules-based software system for researching, analyzing, ordering, procuring, developing contracts for and facilitating and managing the installation of and ongoing post installation management of broadband services. By broadband services, we imply services purchased from ISPs, services such as Internet, Phone and TV.

The invention embodies many unique features that assist the users of the software system. Together this invention enables Customers to manage all their service procurements from a personalized software-based portal. The Portal incorporates Artificial Intelligence (AI) technologies combined with Markup Languages, to construct an Expert System that rapidly matches Customers' needs with ISPs who can fulfill the said needs.

The unique software-based portal enables sales representatives of ISPs worldwide to declare the services they offer. Combined with these declarations, Customer requirements are algorithmically matched to specific ISP Offerings. Reps are integrated directly into the Portal that stores the responses for future re-use and greatly facilitates subsequent analysis. The Reps utilize the invention to rapidly transmit information, enabling communication effectiveness and productivity gains for Reps.

The fundamental design objective of the present embodiment of the invention is a reduction in unstructured data and communication as extant in telephone and email-based processes and a replacement by a formalized, structured database centric view of the procurement process with an accompanied workflow facilitating the same.

### BRIEF DESCRIPTION OF THE FLOWCHARTS AND DIAGRAMS

The present invention will be more fully understood by referencing the following specific example of procurement of Internet Connection Services and the detailed descriptions of the preferred embodiments. Wherein:

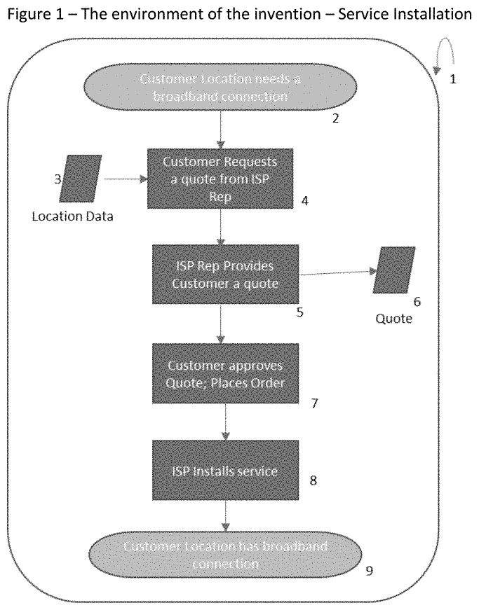

FIG. 1 is a flowchart of an abstracted process in the field of the invention. It depicts the activities that must sequentially take place to achieve the installation of a broadband circuit at a location;

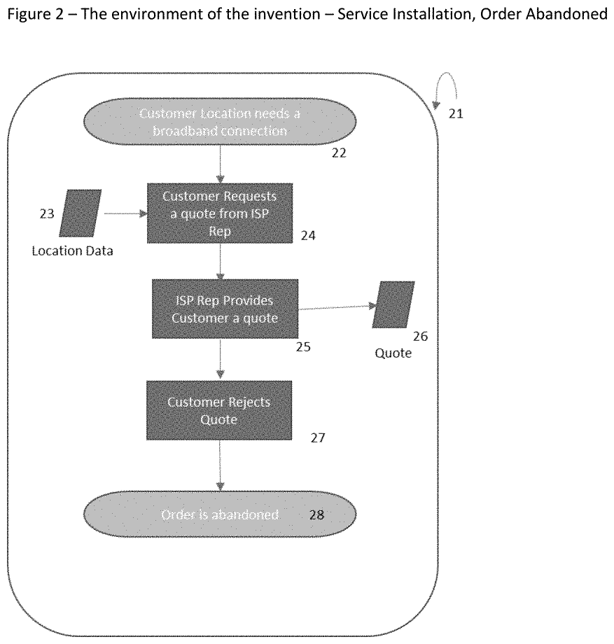

FIG. 2 is a flowchart of an abstracted process in the field of the invention. It depicts the activities that must sequentially take place to achieve the abandonment of an order for a broadband circuit at a location;

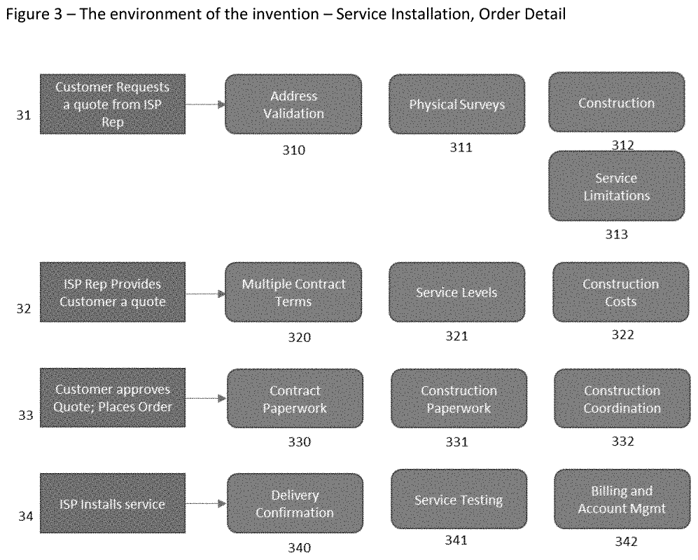

FIG. 3 is a breakdown of activities of an abstracted process in the field of the invention. Each activity is broken down into several constituent activities that must all be accomplished together to achieve the installation of a broadband circuit at a location;

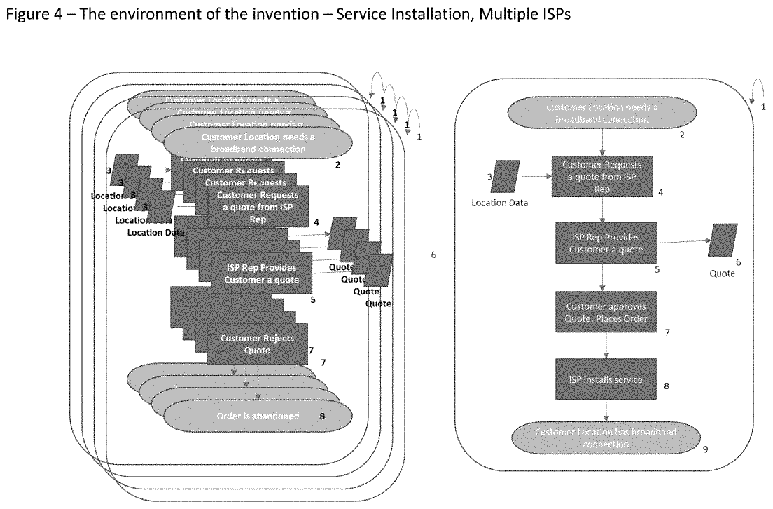

FIG. 4 is a flowchart of an abstracted process in the field of the invention. It depicts the activities that must sequentially take place to achieve the installation of a broadband circuit at a location when a request for quotation is placed upon multiple Reps. Only one request may be converted to an order; others are abandoned.

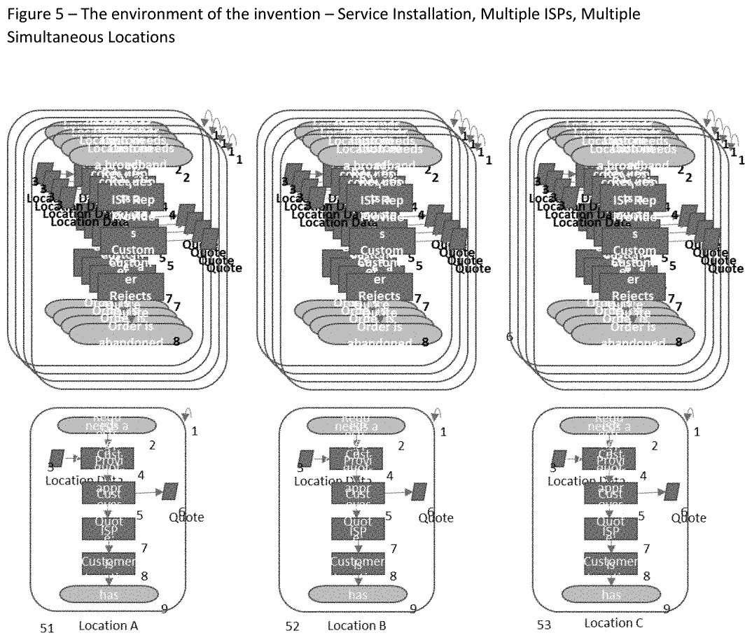

FIG. 5 is a flowchart of an abstracted process in the field of the invention. It depicts the activities that must sequentially take place to achieve the installation of a broadband circuit at a location when simultaneous requests for quotations for broadband procurement for multiple locations are placed upon multiple Reps.

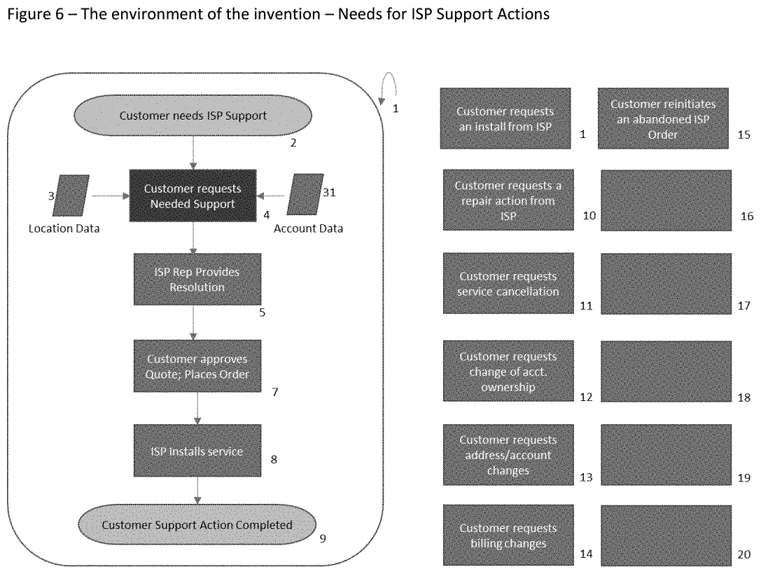

FIG. 6 is a flowchart of an abstracted process in the field of the invention. It depicts the activities that must sequentially take place to achieve the completion of a Customers support request. The data needs to complete the support request will vary depending on the nature of the request;

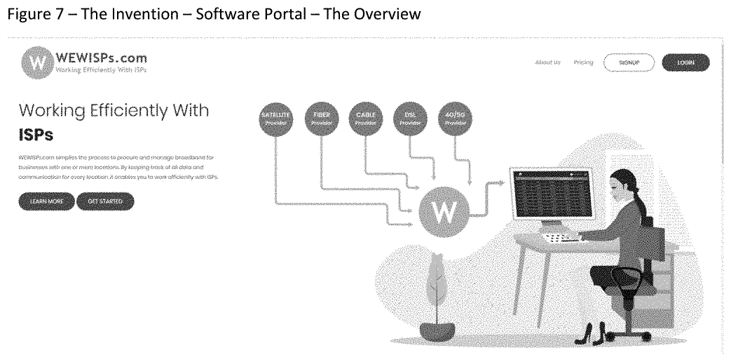

FIG. 7 is an image of a single instantiation of the current implementation of invention. It depicts the software portal that implements the invention;

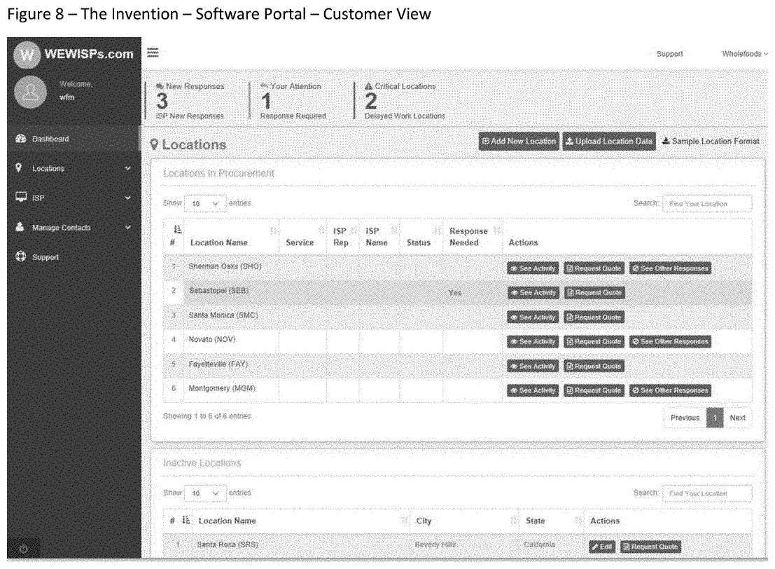

FIG. 8 is an image of a Customer's view of the state of various procurement requests within the current implementation of invention. Among other things, it shows the Customer his locations in different states, including those that need his attentions. One with ordinary skill in the field of the invention will immediately observe how all the complexities of FIG. 5 have been abstracted away by the invention;

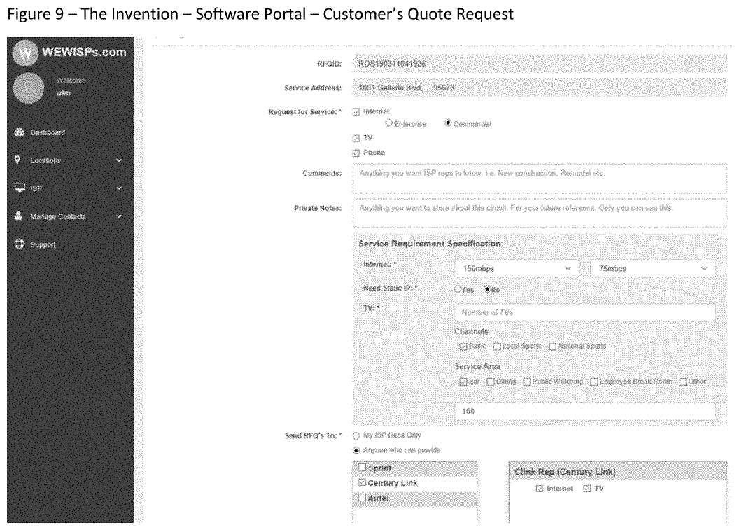

FIG. 9 is an image of a Customer initiating a request for quote for a specific location. One with ordinary skill in the field of the invention will immediately observe the unprecedented ease with which the Customers is able to select the requirements they wish to fulfill. The present invention matches the Customer needs with ISP capabilities in real time and Customers are shown all Reps who can potentially meet their requirements. They simply select the ISPs to whom they wish to send their RFQs and the requirements are emailed to all the Reps they select;

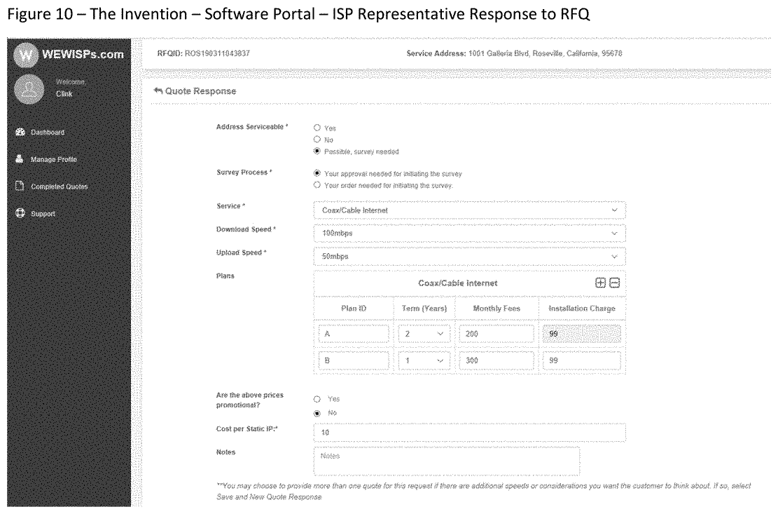

FIG. 10 is an image of a Rep responding to a request for quote for a specific location. One with ordinary skill in the field of the invention will immediately observe the unprecedented ease and completeness with which the Rep is able to respond to a Customer's requirements. Using Intrep-id™ (described below) the Rep is able to respond to a request with a minimum of keystrokes.

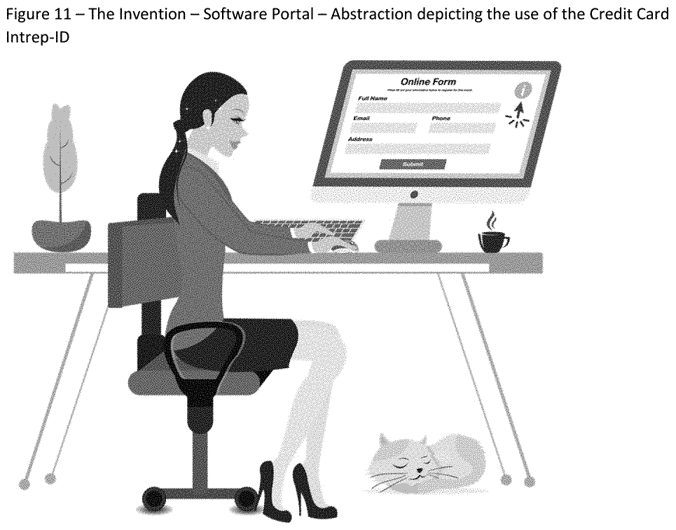

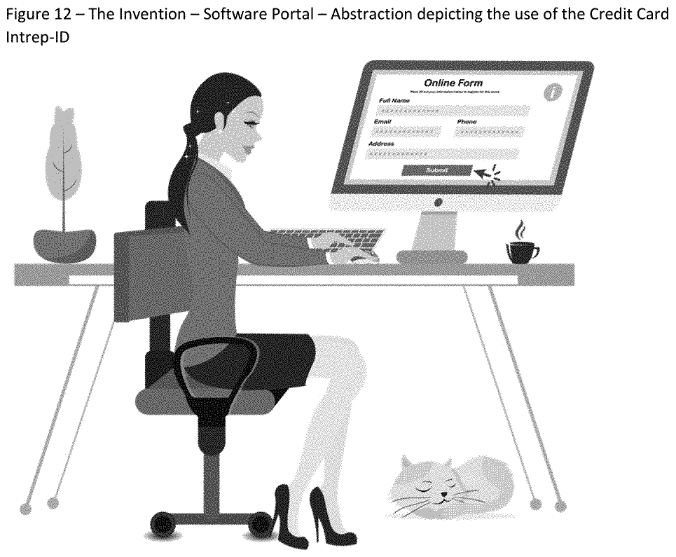

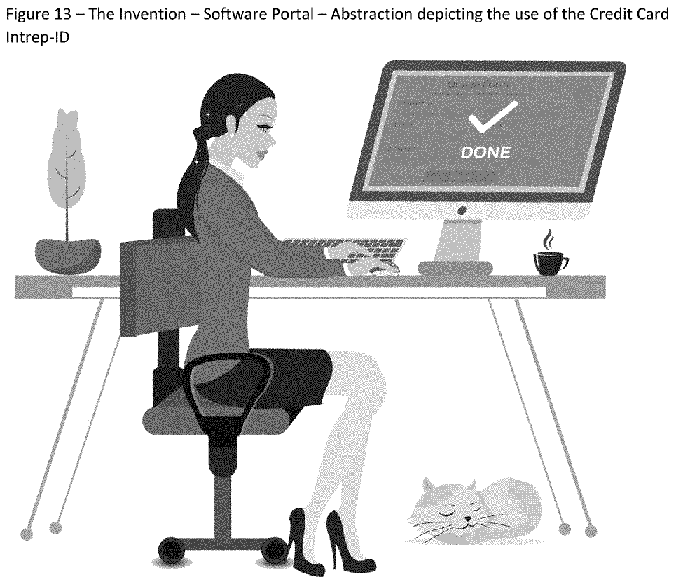

FIGS. 11-13 is an abstraction of a set of transactions depicting the effect of using the Credit Card Intrep-ID™ for the current implementation of invention. Broadband Plan Intrep-IDs allow Reps to provide service quotes in a single click. Credit Card Intrep-IDs enable WEWISPS Customers to repeatedly purchase WEWISPS credits in a single click. In FIG. 11, the customer is shown facing a screen that is asking for the Customer's credit card info. In FIG. 12 the Customer is shown selecting a specific Credit Card Intrep-ID from her computer and uploading it into the Intrep-ID compatible site. FIG. 13 shows the site, having captured and processed the Intrep-ID, showing the Customer's credit card data back to her for verification.

The above figures are provided for the purpose of illustration and description only and are not intended to define the limits of the disclosed invention. The use of a specific User Interface is an embodiment and instance of the invention and one with ordinary skill can easily understand that changing the user interfaces as shown in the accompanied drawings does not change the core of the invention. The figures will be explained or will be within the skill of the art after the following teachings of the present invention have been read and understood.

Furthermore, the invention and the figures above refer specifically to Internet Access Services such as a broadband circuit. However, anyone with ordinary skill can easily understand the same figures, logic and process applies to other broadband services such as telephone and TV procurement or even other services that are procured similarly over the Internet.

### DETAILED DESCRIPTION OF THE INVENTION

As used herein, the term invention refers to the embodiment of features in the invented software system. As used herein, the term software system refers to the WEWISPs.com software and website. WEWISPs stands for “Working Efficiently with ISPs”.

The problems that the present invention addresses are depicted in FIGS. 1 through 6. FIG. 1 depicts an abstraction of the services procurement process (1). The need is the procurement of the broadband connection (2), it is initiated when the Customers makes a request (4) to a Rep and provides the Rep certain data (4) about the location that needs the service. The Rep provides (5) the Customer one or more quotes (6) with varying terms, options and prices. The Customer approves one and places an order (7). The ISP installs the service (8) and the Customer need is fulfilled (9). As is evident to one of ordinary skill in the area of the invention, the above represents a highly abstracted process; the actual process being quite complex.

FIG. 2 depicts the complexity hidden in FIG. 1. To elaborate on this complexity, consider the process of requesting a quote from an SP (31). A given address may be temporary or incorrect, the address must be validated (310). The location may require a physical survey (311) of the property to determine serviceability, it must be evaluated for construction purposes (312) and all of these may place limitations on the services that can be provided. Similarly, providing a quote (32) entails describing several term options (320), different service level agreements (321) and negotiation of construction costs (322) if any. The Order placement (33) is typically followed by the necessary paperwork completion for contracts (330), for construction approval (331) and then the construction itself needs to be overseen and managed (332). After the service is successfully installed (34), much still needs to happen to ensure the delivery of the correct service (341) through testing and other means (342). Following all this there needs to be good data capture that enables efficient billing and account management (342) on an ongoing basis.

As can now be appreciated, what appeared to be a simple process in FIG. 1, is immediately understood in FIG. 2 to be a highly complex process when its component parts are depicted. In many instances, installation request is abandoned or canceled (FIG. 3) because of problems or missed communications in any one of the many activities undertaken.

To appreciate the complexity further, consider that a Customer may wish to research options from multiple ISPs in order to select the best option for her location (FIG. 4). In this circumstance, there will be one to many requests made (1), each following the path outlined in (1) and all but one request will be abandoned, only one succeeds. The communications required to handle multiple ISP requests can be understood to be easily multiplied many folds.

It further needs to be appreciated that the Customer may be a multiple location Customer for example, a multiple store business. It can also be appreciated that it is possible that the Customer may be managing such procurement for more than one location simultaneously (FIG. 5). In this circumstance, all the above complexity mentioned so far not only multiplies but utilizing traditional procurement methods using phone calls and emails can introduce substantial errors and mistakes.

In FIG. 6, we expand the scope of the problem to full lifecycle management of the circuit In the lifetime of the use of the procured service, there will be many requests made from the Customers to the ISP. Whether a repair action is requested (10), or a service cancellation (11), changes in ownership (12), changes in address/account information (13), Billing changes (14) or even going back and reinitiating a previously abandoned order (15), Customers need to interact with the ISPs in many ways in nondeterministic intervals and times. Each such request has a generic flow of actions associated with it, with its own needs for data and information. One with an ordinary knowledge of the field can appreciate the process flows for each of these actions without requiring the present invention to fully itemize such a list of actions.

In summary of the Figures and the foregoing discussion, it can be appreciated that the problems the present invention addresses are significant. As will be described next, the present invention, solves these problems elegantly and effectively by converting information exchanged into a structured database driven, formalized process.

The present invention is an “expert system” in the domain of Broadband management and procurement. It abstracts and instantiates a process that can be utilized by all ISPs and allows for variations therein. It facilitates and records the dialog between Consumers and Reps. The knowledge capture of the field of broadband procurement in the present invention enables the data to be structured from the initiation of the dialog which in turn enables long-term capture and use of the same data to the benefit of Customers and ISPs.

The present invention is embodied in a web application called WEWISPS which is accessible at the Internet URL https wewisps dot com. (FIG. 7).

The Customer is a user/Customer of the WEWISPs service and upon the completion of one or more procurements, will also become a Customer of the ISP they selected. A Customer's dashboard (FIG. 8), depicting instantly the current status of the Customer's procurements, what locations are in active procurement, which ones have received responses and which ones need responses, from the Customer. One with ordinary skill in the field of the invention will immediately observe how all the complexities of FIG. 5 have been abstracted away by the invention;

The Reps form the second set of actors in the present invention. Reps providing a variety of broadband services in a variety of geographies in the US, self-identify their specialties and geographical reach into the system. A unique aspect of the expert system is matching a Customer's requirements and needs to a set of Reps who are then instructed to respond to the said quote request.

The Reps who can provide services and are interested in providing a quote against a specific request provide a quote directly into the WEWISPs system. They do so by logging into the WEWISPs system and entering the data manually (FIG. 10). They can also avoid manual work by using our Intrep-id™ system.

The Intrep-id™ system is a significant invention. After the first manual entry of the requested information, the Intrep-id™ system encodes the entered data into XML instances. The XML instances are encoded for security and sent back to the user as appropriately named files. For subsequent requests by the system for the same data, users simply upload these XML files into the WEWISPS system which precludes having to enter the data manually. FIG. 11, 12, 13 show an abstracted use of the Intrep-id™ system. The key benefits of the Intrep-ID system are enabling a rapid transfer/reuse of arbitrary structured data without having to create accounts with 3^{rd} parties that could render the said data susceptible to being compromised.

Here we introduce a significant component critical to the concept and utility of this invention, Intrep-id™, which facilitates and manages the workflow and contents of the entire business conversation, from initial contact through to installation and operation, between the service customer and the many service providers. In this invention, Intrep-id™ employs a specific XML language, defined within the context of this invention, Broadband Procurement and Management Markup Language™ (BPMML), to encode and transfer data between the Rep's systems and WEWISP. This Open Source Markup Language is trademarked.

The Intrep-id™ system uses another specific XML language, defined within the context of this invention, Credit Card Purchase Management Markup Language™ (CCPMML) to encode and transfer data between the Customer's computer and the WEWISPs web site. This Open Source Markup Language is trademarked [0032] In the present invention, Reps create multiple instances of BPMML compatible XML files. These files reside only on the Rep's computer. Each XML instance contains the quotation data for a service offering of the SP. When the Rep needs to provide this data to the Customers in response to the RFQ, the specific instance is selected and uploaded to WEWISPs. The required data then shows, appropriately in the form and saved and sent to move the transaction forward. The XML instances are encrypted using a key that is shared between the Rep and their account on WEWISPS.

In the present invention, Customers can create one or more instances of CCPMML compatible XML files. These files reside only on the Customers' computers. Each XML instance contains the Credit Card data necessary to charge WEWISPS credits purchases. When the Customers need to provide this data to WEWISPS to execute the transaction, a specific Credit Card instance is selected and uploaded to WEWISPs. The required data then shows appropriately in the form and executed to complete the transactions. The XML instances are encrypted using a key that is shared between the Customers and their account on WEWISPS.

Without needing to show the entire set of communications, including all permutations and combinations of available choices, it can be appreciated by one of ordinary skill in the field of the art, the Reps and the Customers continue to communicate with each other using the WEWISPs system which tracks the deliverables of one to the other, generating alerts when delays are noticed. This process of communication continues until a successful resolution is achieved, that being the installation or effective management of the requested service.

WEWISPS in its first instantiation relates to the procurement and management of Internet Broadband services, including those TV and phone services that are purchased from the ISPs. However, one of ordinary skill will appreciate that the scope of the present invention is not limited to the procurement of just broadband services over the Internet; it is intended to embrace the procurement and support paradigm of any number of current and future services for efficient and effective management.

Intrep-ID™ in its present form is the first instantiation of the first two markup languages, the BPMML and the CCPMML, and associated Intrep-IDs in support WEWISPS needs. However, one of ordinary skill can abstract from the specific WEWISPS based technology to see that it applies to all fields where Consumers need to provide data about themselves to same business partners repeatedly or the same data to multiple competing or non-competing business partners. WEWISPS™ and Intrep-ID™ developments are underway to support many such applications.

All Intrep-IDs are encrypted using an arbitrary fragment of the data that is provided by the Customer to their business partner. This ensures “pretty good privacy” with significant ease of use for the Consumer.

WEWISPS's uniqueness is enumerated below:
a. Automating ISP services procurement and management—a process involving business customers, multiple ISPs with no current/existing computerized tools and processes to do so.
b. Abstracting key process elements and data from multiple different ISP organizations and creating a standard process that could be used for all ISPs, so that a standard workflow could be created to the benefit of Customers.
c. Algorithmically matching service provider capabilities and offerings to customer requests based on the customer requirements for services.
d. Applying structure and database techniques within a consumer services procurement and management process. Users and consumers employ these tools and techniques to conduct rapid, effective, and repeated data exchange of arbitrary personal and business data to achieve their objectives. They achieve this without having to create user accounts and retaining full control of their data and without having to entrust the security of their data to their business partners or other 3^{rd} parties. WEWISPS is the first test of the idea; when successful the basic concepts will transform many applications on the web.

We claim:

1. A system and a process for Broadband Procurement and Management, the process comprising:
all steps that together enable the procurement and management of broadband, TV and phone services; each step combining data and activity to achieve specific purpose in the workflow; the workflow that spans organizations across the Internet; a software portal that encapsulates the online workflow; and

2. The system for bringing together Reps from multiple disparate ISPs into a standard interface, comprising:
a method for Reps to self-disclose their capabilities and territories to the system in a well-defined manner; a method for Reps to review all pending and completed activity; a method that tracks Reps' progress and provides escalation paths; and

3. The system for enabling Customers effectively manage their broadband circuits, comprising:
a process to upload location addresses into said system with the ability to seek best solutions from multiple Reps in a standardized way; a method to maintain a comprehensive view on procurements completed and those underway; a method to efficiently seek updates from Reps and track installations to schedules; a method to manage and maintain multi-location data in a centralized fashion; the centralized data enabling an effective method to request maintenance and management actions on circuits already deployed; and

4. A process to identify most qualified ISP services comprising:
an algorithm to match services required at a location to services offered by ISPs across all geographies, and

5. A process to enable rapid, secure, structured exchange of arbitrary Customer data between Customers and their business partners, comprising:
a method to create, store, encrypt and use arbitrary customer data stored in XML data files on Customer computers that Customers can provide to business partners in a single click when engaged in a transaction with the business partner; the said method trademarked under the tradename Intrep-ID™; and
A specific instance of the general Intrep-ID™ process to enable rapid and secure responses by Reps to Customers Quote Requests within the WEWISPS system, comprising:
a method to create, store and use encrypted service plan data stored in XML data files on Rep computers that Reps can provide in a single click when responding to Customers Quote Requests; the said method trademarked under the tradename Intrep-ID™; and
A specific instance of the general Intrep-ID™ process to enable rapid and secure responses by Customers to repeatedly purchase WEWISPS credits within the WEWISPS system, comprising:
a method to create, store and use Credit Card data stored in XML data files on Customers computers that Customers can provide in a single click when purchasing WEWISPS credits to use the WEWISPS system for procurement and management of broadband and related services; the said method trademarked under the tradename Intrep-ID™
